(19) United States
(12) Patent Application Publication
(10) Pub. No.: US 2025/0207997 A1
(43) Pub. Date: Jun. 26, 2025

(54) DENOISING OPTICAL TIME-DOMAIN REFLECTOMETRY SIGNALS

(71) Applicant: EXFO Inc., Québec City (CA)

(72) Inventors: Jonathan PLANTE, Montreal (CA); Renaud LESPERANCE, Montreal (CA); Sylvain NADEAU, Vaudreuil-Dorion (CA); Vincent DEMERS-CARPENTIER, Quebec City (CA)

(73) Assignee: EXFO Inc., Québec City (CA)

(21) Appl. No.: 18/981,957

(22) Filed: Dec. 16, 2024

Related U.S. Application Data
(60) Provisional application No. 63/613,507, filed on Dec. 21, 2023.

(51) Int. Cl. G01M 11/00

(52) U.S. Cl. CPC G01M 11/3145; G01M 11/3127

(57) ABSTRACT

Systems and methods for performing Optical Time-Domain Reflectometry (OTDR) tests on optical fibers are provided. In an embodiment, a method includes applying OTDR pulses to a fiber under test and receiving noisy acquisition sets of the fiber under test; processing the noisy acquisition sets with a denoising model that is a pre-trained machine learning model configured to simultaneously use spatial information and temporal information associated with the noisy acquisition sets to filter out noise; and analyzing outputs from the denoising model to determine characteristics of the fiber under test. This approach is performed in lieu of the conventional approach of mathematically averaging acquisitions, thereby resulting in proper results with fewer acquisitions, significantly speeding up the overall acquisition time.

### CROSS-REFERENCE

The present disclosure claims priority to U.S. Provisional Patent Application No. 63/613,507, filed Dec. 21, 2023, the contents of which are incorporated by reference in their entirety.

### TECHNICAL FIELD

The present disclosure generally relates to optic fiber testing systems and methods. More particularly, the present disclosure relates to Optical Time-Domain Reflectometry (OTDR) and denoising OTDR signals.

### BACKGROUND

During an OTDR measurement, laser pulses are sent through an optical fiber and the backscattered photons are measured, providing valuable information on the condition of the fiber along the optical path. Because of the inherent attenuation of optical media components, such as optical fibers, the forward and reflected signals get weaker the farther they travel. Thus, in a typical OTDR measurement, the optical power of the signals covers several orders of magnitude (usually expressed in dB). An OTDR has several configurable parameters such as, e.g., pulse width, averaging time, wavelength, Avalanche Photodiode (APD) gain, etc. The size of the pulse width is selected in accordance with the length of the fiber under test in order to optimize/reduce acquisition time. A longer length requires a larger pulse width. The dynamic range is the ratio between the highest measurable signal and the lowest measurable signal and depends on optical saturation at the top of the range and the noise floor at the bottom. OTDR measurements typically aim to characterize a fiber, i.e., looking for events such as a junction between fiber sections (spliced or connected), macro bends, fiber breaks, etc. To detect events or measure events, a sufficient dynamic range and resolution are necessary. Also, in an OTDR measurement, the measurement time is the overall time it takes to acquire and denoise the OTDR signal from the fiber under test. Specifically, a conventional OTDR trace includes an average of many acquisitions to provide a clearer, more accurate view of the fiber under test. Of note, the terms “fiber under test” and “fiber” may be used interchangeably herein.

In general, while these parameters are configurable, making concessions to improve the acquisition time comes at the expense of a loss of resolution (less accurate event detection). Of course, there is a strong need to lower acquisition time, to increase productivity to follow the demand for more and more optical fiber to be installed and tested. Conventionally, faster acquisition therefore come with significant drawbacks:
(1) Lowering acquisition time will increase noise level, preventing the measurement of certain reflectometric signatures.
(2) Improving optical and electronic components to increase signal-to-noise ratio (SNR) will significantly increase the cost of the instruments.
(3) Use of a larger pulse width at the cost of resolution.
(4) Classically, denoising is typically performed by mathematically averaging acquisitions. Averaging requires time, as an increasing number of acquisitions are needed to filter out the noise, namely the number of acquisitions (n) needed to improve the Signal-to-Noise Ratio (SNR) increases quadratically, i.e., 4× acquisition time means 2× improvement in SNR. This directly contributes to the OTDR test duration.

For applications such as high-fiber-count, where test time needs to be minimized, the objective is to achieve the appropriate dynamic range in less time without loss of resolution, i.e., with fewer acquisitions while maintaining the measurement resolution.

### BRIEF SUMMARY

The present disclosure relates to Optical Time-Domain Reflectometry (OTDR) devices and methods for performing OTDR tests on optical fibers. Specifically, the OTDR device incorporates a denoising module, and the corresponding method includes a denoising step. Both the denoising module and the denoising step utilize a pre- trained machine learning model designed to filter or denoise noisy OTDR acquisitions in both the time domain (temporal) and space domain (spatial). This advanced approach replaces the conventional method of mathematical averaging of multiple acquisitions, which is traditionally used to suppress noise.

The disclosed denoising process offers several key advantages. By leveraging machine learning algorithms trained on a wide range of OTDR datasets, the model efficiently extracts meaningful signals from noisy data, producing a denoised OTDR trace with higher accuracy and reliability. This enables the acquisition of proper results with significantly fewer measurements, thereby reducing the number of acquisitions required for reliable results. This leads to a substantial improvement in test efficiency, as the overall acquisition time is reduced without compromising data integrity or quality. Furthermore, the pre-trained machine learning model is adaptable to various noise levels and fiber conditions, making it suitable for diverse optical testing scenarios. This enhanced capability ensures more effective troubleshooting, monitoring, and maintenance of optical networks, particularly in high-speed and large-scale deployments where time efficiency is critical.

In an embodiment, the present disclosure includes a method having steps, an OTDR device configured to implement the steps, and a non-transitory computer-readable medium storing instructions that, when executed, cause one or more processors to perform the steps. The steps can include applying OTDR pulses to a fiber under test and receiving noisy acquisition sets of the fiber under test; processing the noisy acquisition sets with a denoising model that is a pre-trained machine learning model configured to simultaneously use spatial information and temporal information associated with the noisy acquisition sets to filter out noise; and analyzing outputs from the denoising model to determine characteristics of the fiber under test.

The steps can further include providing or displaying a denoised OTDR trace. The denoising model can include multiple convolutional feature extractor layers configured to extract features from the spatial information and the temporal information of the reflectometric signatures. The denoising model can perform steps of receiving the noisy acquisition sets and extracting information across multiple ones of the noisy acquisition sets; processing in parallel the noisy acquisition sets via a plurality of 1D convolutional layers each with different kernel sizes; concatenating outputs of the plurality of 1D convolutional layers and processing the outputs via another 1D convolutional layer; and providing an output corresponding to a prediction that is a combined, filtered version of the noisy acquisition sets.

The processing can utilize the denoising model to filter out noise to reduce overall measurement time relative to averaging the noisy acquisition sets over time to filter out the noise. The denoised OTDR trace can be provided after a first pass of the noisy acquisition sets through the denoising model, and the steps can further include updating the denoised OTDR trace based on improvements thereto based on subsequent passes through the denoising model. The denoising model can be one of a Neural Network (NN), a Recurrent Neural Network (RNN), and a Convolutional Neural Network (CNN). The denoising model can include multiple passes, and wherein, after each forward pass, the denoising model is configured to output a denoised signal and retain a hidden state of the fiber under test.

In another embodiment, an Optical Time-Domain Reflectometer (OTDR) apparatus includes an acquisition module configured to apply OTDR pulses to a fiber under test and receive noisy acquisition sets based thereon; a denoising module connected to the acquisition module and configured to receive the noisy acquisition sets therefrom, wherein the denoising model is a pre-trained machine learning model configured to simultaneously use spatial information and temporal information associated with the noisy acquisition sets to filter out noise in the noisy acquisition sets; and a trace analysis module connected to the denoising module and configured to use outputs from the denoising module to provide a denoised OTDR trace.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a diagram illustrating a fiber testing arrangement according to one embodiment.

FIG. 2 is a block diagram illustrating the Optical Time-Domain Reflectometry (OTDR) device shown in FIG. 1, according to various embodiments.

FIG. 3A is a diagram illustrating simultaneous spatial and temporal noise filtering of noisy OTDR acquisition sets to provide a denoised OTDR trace using the OTDR device shown in FIG. 2, according to various embodiments.

FIG. 3B is a diagram illustrating a recurrent denoising component of the denoising module shown in FIG. 2, according to various embodiments.

FIG. 3C is a diagram illustrating denoising model of the recurrent denoising component of FIG. 3B, according to various embodiments.

FIG. 4 is a block diagram illustrating another denoising device of the denoising module shown in FIG. 2, according to various embodiments.

FIGS. 5A-5B are graphs showing examples of OTDR traces of an optical fiber under test.

FIG. 6 is a flow diagram illustrating a method for performing an OTDR test having a denoising function, according to various embodiments.

### DETAILED DESCRIPTION

The present disclosure relates to systems and methods for reducing noise in OTDR signals during testing of an optical fiber. This noise-reduction process, referred to as “denoising,” can be implemented as a denoising module within an OTDR system or as a denoising step within an OTDR measurement method. For the purposes of this disclosure, the denoising module and the denoising step are considered functionally equivalent and may collectively be referred to as “denoising.” The denoising functionality employs a pre-trained machine learning (ML) model, such as a neural network-based model, specifically designed to filter noise. Functionally, the denoising module is situated between the acquisition module—which performs tests and obtains signal data from the fiber under test—and the OTDR trace analysis module. The denoising module is trained to maximize the filtration of non-coherent noise and reduce some coherent noise, while preserving the reflectometric signatures essential for analyzing the fiber's condition. In one embodiment, the denoising module leverages a neural network that processes spatial and temporal information simultaneously from the acquisitions, enabling a comprehensive and efficient noise reduction process.

The advantages of denoising OTDR signals include faster measurements and improved test performance. By reducing the number of acquisitions needed to generate a reliable OTDR trace, the disclosed system enables efficient testing without compromising quality. This enhancement is particularly beneficial for longer optical fibers, as it ensures that noise does not obscure critical signal characteristics, such as attenuation or fault locations. The dynamic range of OTDR tests-critical for analyzing long-distance fibers-can also be improved. While traditional OTDR systems often rely on high-quality optical and electronic components to achieve a higher dynamic range, this approach can significantly increase instrument costs, which may not always be feasible for customers. The disclosed method provides a cost-effective alternative by minimizing the dependence on expensive hardware while maintaining performance.

Traditionally, increasing the dynamic range involves longer acquisition times, where a series of laser pulses are used to scan the optical fiber. This allows the dominant non-coherent noise to be averaged out over time. However, this method is often impractical, especially for technicians tasked with testing dozens, hundreds, or even thousands of fibers at a site. The need to reduce acquisition times without compromising performance is paramount for maintaining productivity during fiber installation and testing in large-scale networks. While conventional approaches can reduce noise by extending acquisition times, they also significantly slow the testing process, creating bottlenecks and reducing efficiency. For technicians in the field, this inefficiency can result in higher labor costs and delayed deployments.

Faster acquisition methods in traditional systems often come with significant trade-offs. Reducing acquisition times usually fails to adequately suppress noise, which can result in the loss of critical reflectometric signatures. Alternatively, using high-end optical and electronic components to improve the Signal-to-Noise Ratio (SNR) increases costs dramatically. Another common approach—selecting a wider pulse width—improves SNR but reduces the spatial resolution, limiting the ability to pinpoint faults or anomalies within the fiber.

The present disclosure addresses these limitations by introducing systems and methods that leverage neural network-based denoising to improve OTDR performance. Unlike conventional systems that rely on classical averaging over extended acquisition periods, the disclosed method uses ML-powered denoising to reduce the number of acquisitions required to produce a usable OTDR trace. A key innovation of this disclosure is the ability to process multiple acquisition sets simultaneously using the ML model. This parallel ingestion of data significantly enhances the denoising process, reducing acquisition times while preserving signal integrity. By implementing the denoising logic after the acquisition stage and before the trace analysis stage, the system ensures a seamless integration into existing OTDR workflows.

Overall, the disclosed systems and methods provide a highly efficient, cost-effective, and scalable solution for denoising OTDR signals, making them particularly suited for large-scale optical network deployments where speed, accuracy, and cost-effectiveness are critical.

### OTDR

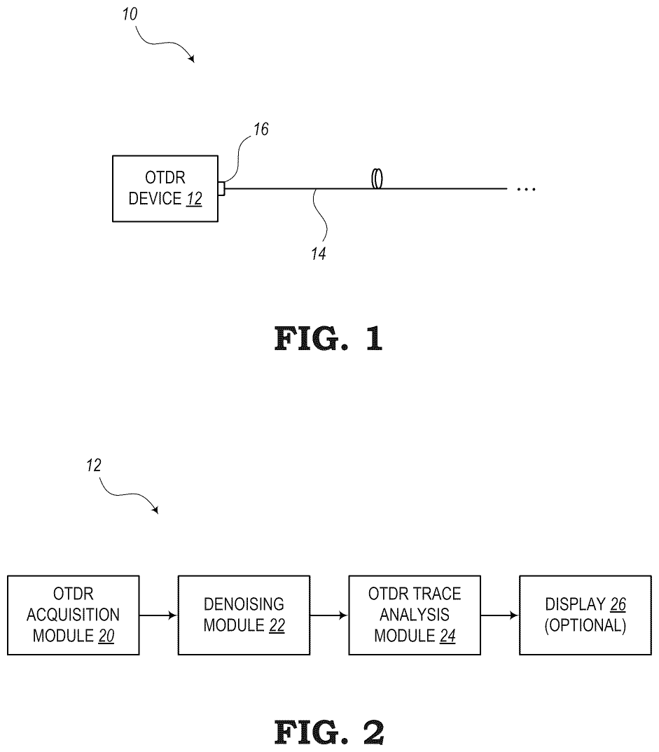

FIG. 1 is a diagram illustrating an example of a fiber testing arrangement 10 for performing OTDR tests. In this embodiment, the fiber testing arrangement 10 includes an OTDR device 12 connected to an optical fiber under test 14 via an optical connector 16. The OTDR device 12 generates and transmits laser pulses into the near end of the optical fiber 14. These pulses travel through the fiber, interacting with its structural elements, and generate reflectometric signatures that are returned to the OTDR device 12 for analysis. By processing these reflectometric signatures, the OTDR device 12 determines the condition of the optical fiber 14, identifying potential faults, discontinuities, or other anomalies.

The reflectometric signatures captured by the OTDR device 12 are complex signal patterns, rather than simple pulse-like responses. These patterns result from multiple reflections occurring along the optical fiber 14 and its associated optical components. OTDR employs time-based processing, which allows it to determine the distance or location along the fiber 14 where specific conditions, such as faults or irregularities, are present.

Discontinuities in the forward OTDR signal—caused by structural or environmental anomalies along the fiber—can lead to backscattering or attenuation of the signal. Example common discontinuities include:
(1) Fiber cuts: Complete breaks in the optical fiber.
(2) Fiber bends: Excessive bending of the fiber that induces optical loss.
(3) Crimps: Physical deformations that disrupt signal integrity.
(4) Dirty connectors: Contaminated or improperly mated connectors causing signal attenuation.

The OTDR device 12 analyzes the optical power loss and other characteristics in the returned signals to detect these discontinuities. Specific signal behaviors associated with various faults include:
(1) Backscattered signals: Generated by structural anomalies such as bends or crimps, which reflect portions of the forward signal.
(2) Attenuation signals: Observed as a reduction in signal strength due to issues like fiber bending or dirty connectors.
(3) Step losses: Abrupt drops in signal power that are indicative of fiber cuts or splice losses.

By interpreting these signal patterns, the OTDR device 12 can generate a comprehensive trace analysis that maps the fiber's condition, identifies fault locations, and provides detailed diagnostics for maintenance or repair.

OTDR with a Denoising Module

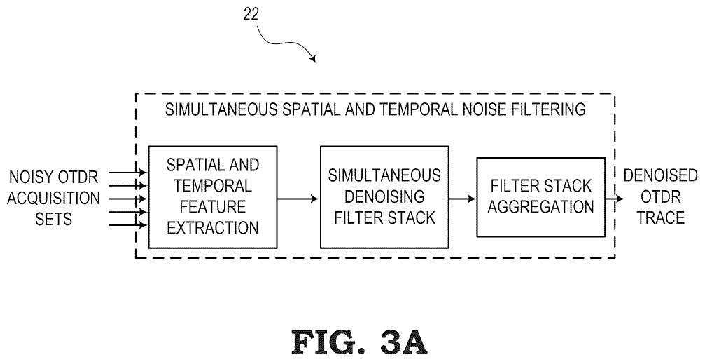

FIG. 2 is a block diagram illustrating an embodiment of the OTDR device 12, previously shown in FIG. 1. In this embodiment, the OTDR device 12 includes four primary components: an OTDR acquisition module 20, a denoising module 22, an OTDR trace analysis module 24, and a display 26. Unlike conventional OTDR devices that typically only include an acquisition module and a trace analysis module, this design incorporates the denoising module 22 to enhance the performance of the device 12. By inserting the denoising module 22 between the acquisition module 20 and the trace analysis module 24, the system can achieve improved acquisition speed and dynamic range. The term “modules” as used herein refers to combinations of hardware (e.g., electrical and optical circuitry, processing units), software, and/or firmware. The OTDR device 12 is a physical piece of equipment that connects to an optical fiber under test, and its modules (20, 22, 24) describe distinct functional roles within the system.

The OTDR acquisition module 20 is responsible for transmitting laser pulses into the near end of the optical fiber under test (e.g., optical fiber 14) and receiving the returned reflectometry signals. These signals, often referred to as noisy OTDR acquisitions, serve as the input for further processing. The denoising module 22 incorporates a pre-trained machine learning model to process these noisy acquisition sets. Depending on the specific implementation, the model may include a Neural Network (NN), a Recurrent Neural Network (RNN), a Recursive Neural Network (RvNN), or a Convolutional Neural Network (CNN). This module processes the acquisitions using both spatial information and temporal information simultaneously, enabling it to extract meaningful signal patterns and reduce noise effectively.

In an OTDR trace, spatial information refers to data that corresponds to the physical locations along the optical fiber, indicating where events such as faults, bends, splices, or connectors occur. This spatial data is derived from the timing of the backscattered or reflected light as it travels through the fiber and interacts with discontinuities or structural changes. Each point on the trace correlates to a specific distance along the fiber, enabling precise localization of events. Temporal information, on the other hand, relates to the dynamic behavior of the signal over time, including variations in noise, signal power, and reflections caused by environmental factors or operational changes. Temporal data helps in identifying patterns, trends, or anomalies that may not be immediately evident in the spatial dimension alone. By combining both spatial and temporal information, OTDR traces provide a detailed and comprehensive view of the fiber's condition, ensuring accurate diagnostics and effective monitoring.

The denoising module 22 is designed to filter out non-coherent noise and reduce coherent noise while preserving critical reflectometric signatures. These signatures are essential for accurately diagnosing the condition of the optical fiber under test. The module is optimized for fast processing with minimal CPU usage, ensuring it adds as little delay as possible to the data stream.

Two key objectives are addressed:
(1) Improving acquisition speed while maintaining compatibility with standard hardware.
(2) Preserving resolution and dynamic range in the processed OTDR trace.

The performance of the denoising module 22 is evaluated based on the number of acquisitions required or the total acquisition time necessary to generate an OTDR trace of comparable quality (e.g., resolution and dynamic range) to conventional approaches. By leveraging machine learning, the OTDR device 12 can rapidly present the processed reflection signatures on the display 26, which may be an oscilloscope or a graphical user interface.

The denoising module 22 is capable of ingesting acquisition sets and utilizing spatial and temporal information simultaneously. When implemented with an RNN, the module 22 can retain a hidden state that evolves as more acquisition sets are processed. This enables the denoising module 22 to output an improved denoised signal after each forward pass, progressively refining the trace. The OTDR trace analysis module 24 can then use the enhanced trace to refine its diagnostics and present accurate results on the display 26.

This process can be repeated iteratively until a steady state is achieved, ensuring the highest quality trace for analysis. The repeated application of the denoising module 22 makes it possible to handle challenging scenarios, such as highly noisy environments or long-distance fiber tests, with greater efficiency.

The machine learning-based denoising stage employed by the denoising module 22 allows for faster measurements while maintaining high performance. Non-coherent noise, a significant contributor to the noise floor, typically requires longer acquisition times to reduce its impact. For example, to reduce non-coherent noise by a factor of 2, acquisition time needs to increase by a factor of 4. This quadratic relationship highlights the inefficiency of traditional approaches, especially in scenarios requiring rapid testing.

The denoising module 22 eliminates this limitation by using its machine learning model to extract relevant signals without relying solely on longer acquisition times. This not only reduces the time required for testing but also minimizes the dependency on specialized hardware or overly high detection thresholds.

### Denoising Module

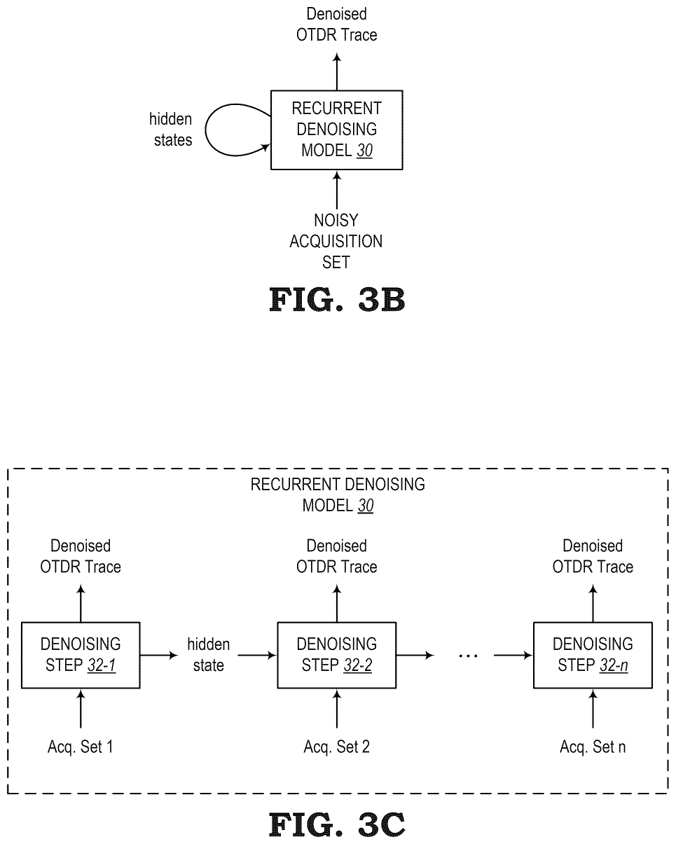

FIG. 3A illustrates the process of simultaneous spatial and temporal noise filtering performed by the denoising module 22 to generate a denoised OTDR trace, as part of the OTDR device 12 described in FIG. 2. The denoising module 22 receives noisy OTDR acquisition sets from the OTDR acquisition module 20 and applies advanced filtering techniques that integrate both spatial and temporal components. These filtering techniques involve spatial and temporal feature extraction and the application of a simultaneous denoising filter stacks, enabling enhanced noise reduction and trace clarity.

In this context, spatial components correspond to data points along the optical fiber within a single acquisition set. These points are typically represented in meters, indices (depending on phase and sampling rates), or time. Conversely, temporal components reflect variations in the intensity or signal level at each spatial point across multiple acquisition sets. Temporal data provides insights into how specific events evolve over time and helps distinguish meaningful signal events from non-coherent noise.

For example, if a 10-second acquisition process involves capturing 10 acquisition sets, each represents a 1-second segment containing its own spatial information. Temporal components emerge when comparing the evolution of specific points across these acquisition sets. While acquisition sets can vary in duration, their alignment enables the denoising module 22 to handle both spatial and temporal aspects in parallel or sequentially (e.g., using a RNN). This dual-component approach provides a distinct advantage over conventional methods that typically address spatial and temporal dimensions separately.

FIG. 3B depicts an embodiment of a recurrent denoising model 30, a component of the denoising module 22. This model may be implemented as part of an RNN integrated into the OTDR device 12 to denoise reflectometric signatures before trace analysis. FIG. 3C illustrates the denoising procedure as a series of steps (32-1, 32- 2, . . . , 32-n), representing the recursive denoising process carried out by the recurrent denoising model 30. Together, these steps demonstrate how noisy OTDR acquisition sets are incrementally refined to produce high-quality traces.

Each acquisition set, labeled 1 through n, represents independent groups of acquisitions for the same optical fiber link, captured at different time intervals. These sets may consist of individual acquisitions or a running average of previous acquisitions up to that point in time. After processing each acquisition set, the recurrent denoising model 30 outputs a refined prediction of the OTDR trace for the fiber link. Importantly, the model retains critical information about the fiber link within its hidden states, allowing it to combine historical data with new acquisition sets at each recurrent step.

This iterative process enables the model to continuously refine its output, ensuring the denoised trace improves in quality with each step. Hidden states serve as a memory mechanism, preserving essential information from past inputs while dynamically incorporating new data for comprehensive noise reduction.

A major advantage of the recurrent model is its ability to iteratively refine the denoised OTDR trace as many times as necessary to reduce noise and increase the dynamic range of the OTDR signals. The number of iterations (n) is flexible and can be adjusted based on the testing requirements. After each step, the hidden state summarizes all prior data, enabling seamless denoising without losing important contextual information. This flexibility allows the OTDR device 12 to either stop or continue acquisitions as needed, based on automatic criteria (e.g., detecting a steady-state condition) or manual user inputs (e.g., custom settings defined on the device).

The OTDR device 12 can provide a quick initial display of the fiber's condition based on the first denoised signal. It can then continue testing over time to refine the OTDR trace, reducing noise components and making the fiber's characteristics more apparent. This capability ensures that even in high-noise environments, the denoised trace accurately reflects the true condition of the fiber.

The denoising steps (32-1, 32-2, . . . , 32-n) progressively combine multiple acquisition sets, extracting key spatial and temporal features to further enhance the denoising process. The result is a highly detailed and accurate OTDR trace, displayed to the user on the device's interface (e.g., display 26), which facilitates diagnostics, fault localization, and overall fiber performance assessment.

### Example Architectures

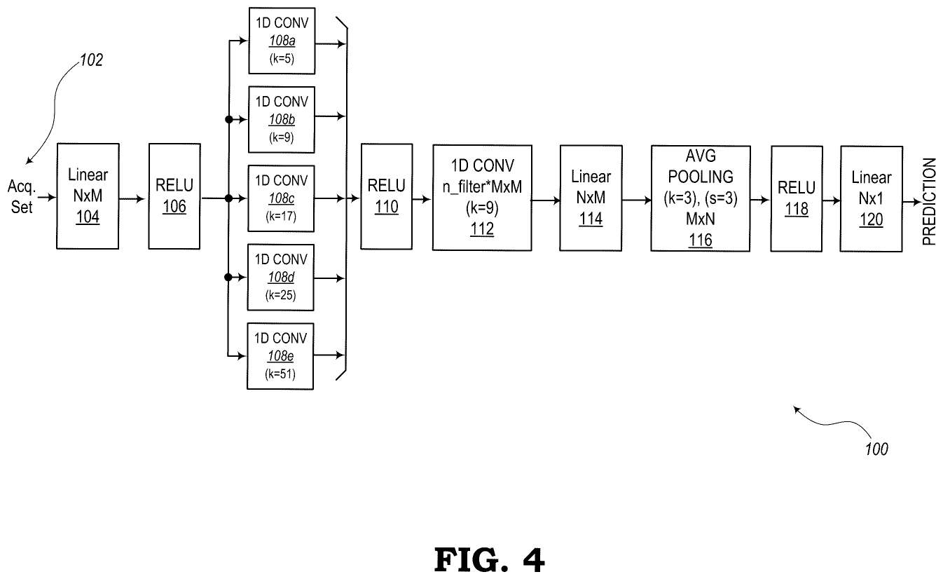

FIG. 4 is a block diagram illustrating an alternative embodiment of a denoising device 100 within the denoising module 22. This device is designed to process N acquisition sets 102 of noisy data, using advanced neural network techniques to generate a clean, denoised output. The denoising process begins with a linear layer 104, followed by an activation unit, specifically a ReLU (Rectified Linear Unit) 106. The ReLU 106 is an example of a non-linear activation function, which introduces complexity to the model by enabling it to learn non-linear mappings. While ReLU is the default choice, alternative activation functions such as LeakyReLU or GELU (Gaussian Error Linear Unit) may also be used. This initial step extracts important information from all acquisition sets for a given point, preparing the data for further processing.

Next, the data flows into a set of five parallel filter blocks 108a-108e, each performing 1D convolutions with distinct kernel sizes (k). These kernel sizes determine the “sliding viewing window” size of each convolution, enabling the device to extract features at multiple temporal and spatial scales. By using different kernel sizes, the filter blocks capture a range of characteristics from short-term fluctuations to broader patterns, enhancing the device's ability to analyze both spatial features (across the fiber) and temporal features (across multiple acquisition sets).

The outputs from these filter blocks are then concatenated, combining their diverse perspectives into a unified feature set. This combined output is passed through another ReLU 110 to introduce non-linearity and activate relevant features. The processed data is then further refined through a series of 1D convolutional layers and blocks (112, 114). These layers intelligently aggregate the filtered outputs, leveraging the features extracted by the parallel filter blocks. This step ensures that meaningful patterns are preserved while noise and irrelevant details are suppressed.

An average pooling layer 116 is then applied. This layer groups channels with similar features or behaviors by averaging their activations, effectively consolidating redundant information. The pooling operation uses a kernel size (k) and stride(s) set to the same value, ensuring uniform aggregation across the data. Finally, the pooled data is processed through additional layers (118, 120) that combine all grouped channels into a single final prediction. These final layers ensure that the denoising device produces a coherent and accurate output, representing the denoised OTDR trace.

This architecture enables the denoising device 100 to efficiently process noisy OTDR acquisition sets by leveraging spatial and temporal filtering, intelligent aggregation, and advanced neural network techniques. The result is a high-quality denoised signal suitable for analysis and display by the OTDR system.

### Additional Example OTDR Traces

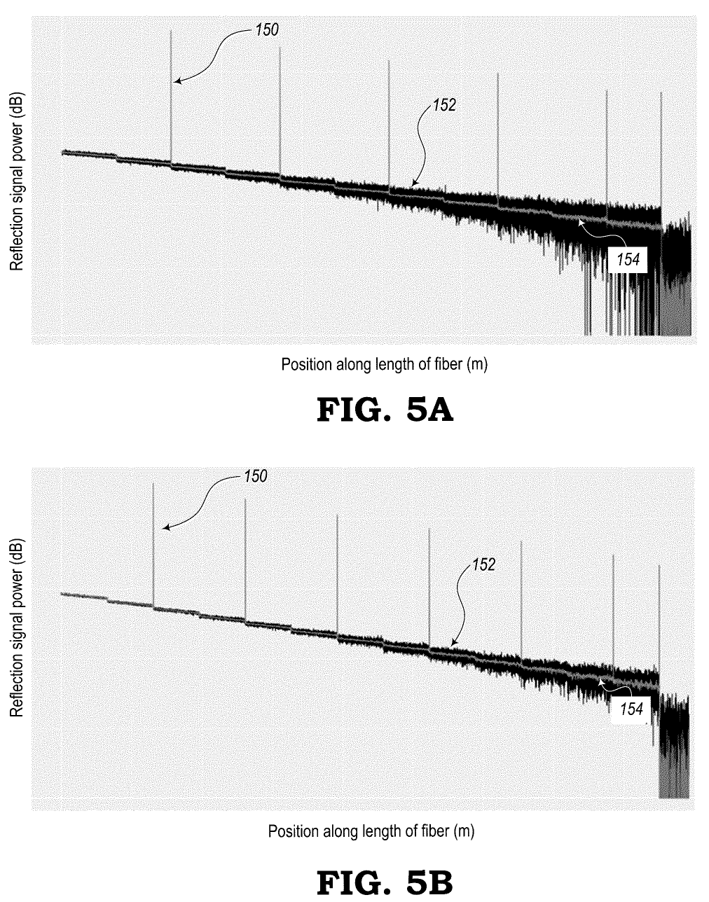

FIGS. 5A-5C are graphs showing examples of OTDR traces of an optical fiber under test. Line 150 show the Ground truth, lines 152 show an input acquisition set that is denoised using the classical approach (averaging), and lines 154 show denoising using the approach described herein. FIG. 5A is for a wavelength of 1650 nm and a pulse of 5 ns. The acquisition sets for the classical approach and the denoising module input is 10×500 avg (10 acquisition sets in parallel, each acquisition set composed of 500 acquisitions average). FIG. 5B is for a wavelength of 1650 nm and a pulse of 10 ns. The acquisition sets for the classical approach and the denoising module input is 10×750 ms. Those two are provided to show an example using different pulses or/and different acquisition method (avg or time).

### Method

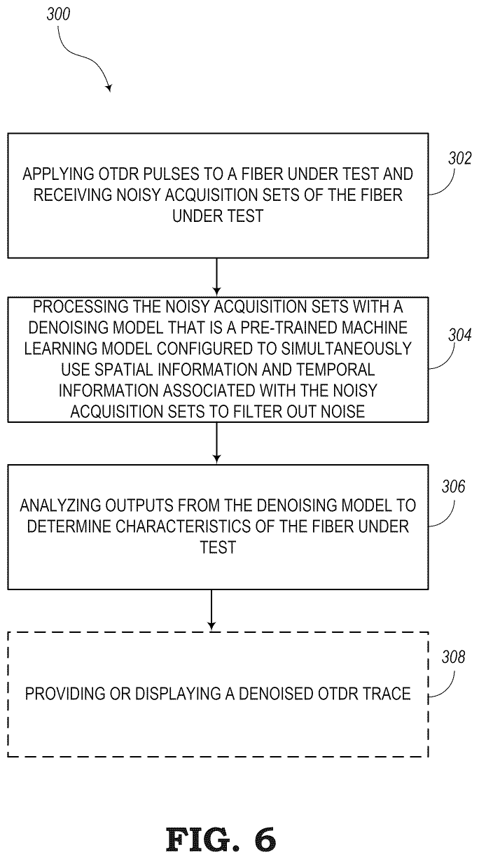

FIG. 6 is a flow diagram illustrating an embodiment of a method 300 for performing an OTDR measurement on an optical fiber under test, where the OTDR test includes denoising functionality. The method 300 includes applying OTDR pulses to a fiber under test and receiving noisy acquisition sets of the fiber under test (step 302); processing the noisy acquisition sets with a denoising model that is a pre-trained machine learning model configured to simultaneously use spatial information and temporal information associated with the noisy acquisition sets to filter out noise (step 304); and analyzing outputs from the denoising model to determine characteristics of the fiber under test (step 306). The steps can further include providing or displaying a denoised OTDR trace (step 308).

The denoising model can include multiple convolutional feature extractor layers configured to extract features from the spatial information and the temporal information of the reflectometric signatures. The denoising model can perform steps of receiving the noisy acquisition sets and extracting information across multiple ones of the noisy acquisition sets; processing in parallel the noisy acquisition sets via a plurality of 1D convolutional layers each with different kernel sizes; concatenating outputs of the plurality of 1D convolutional layers and processing the outputs via another 1D convolutional layer; and providing an output corresponding to a prediction that is a combined, filtered version of the noisy acquisition sets.

The processing can utilize the denoising model to filter out noise to reduce overall measurement time relative to averaging the noisy acquisition sets over time to filter out the noise. The denoised OTDR trace can be provided after a first pass of the noisy acquisition sets through the denoising model, and the steps can further include updating the denoised OTDR trace based on improvements thereto based on subsequent passes through the denoising model. The denoising model can be one of a Neural Network (NN), a Recurrent Neural Network (RNN), and a Convolutional Neural Network (CNN). The denoising model can include multiple passes, and wherein, after each forward pass, the denoising model is configured to output a denoised signal and retain a hidden state of the fiber under test.

### ML Model

A trained machine learning (ML) model can denoise an OTDR trace by learning to separate noise from genuine signal components through advanced data-driven algorithms. Common types of ML models used for this purpose include Convolutional Neural Networks (CNNs), Recurrent Neural Networks (RNNs), and hybrid architectures like Convolutional-Recurrent Networks (CRNs). These models are trained using large datasets comprising noisy OTDR signals paired with their corresponding clean, denoised traces. The training process involves supervised learning, where the model minimizes a loss function (e.g., mean squared error) to reduce the difference between its predicted output and the ground truth denoised trace. Training may also incorporate data augmentation to simulate varying noise levels and signal conditions, making the model robust to real-world scenarios.

The models process noisy OTDR acquisitions by extracting spatial features (patterns along the fiber at specific distances) and temporal features (variations in signal intensity across acquisition sets). CNNs are particularly effective for spatial filtering because of their ability to capture localized patterns with convolutional kernels. RNNs or their variants, such as Long Short-Term Memory (LSTM) networks, excel at temporal filtering by maintaining a “memory” of sequential data, which helps distinguish consistent signal patterns from random fluctuations over time. Hybrid models combine these strengths, processing spatial and temporal dimensions simultaneously to achieve superior denoising performance.

The advantages of ML-based denoising include significant improvements in speed, resolution, and dynamic range. Traditional OTDR methods rely on averaging a large number of acquisitions to reduce noise, which increases acquisition time and can blur fine details in the trace. In contrast, ML models require fewer acquisitions by leveraging their pre-trained knowledge to efficiently extract the true signal, even in high-noise environments. This enables faster testing while preserving or enhancing the trace resolution, making ML-based denoising ideal for applications requiring high precision, such as long-haul fiber testing or rapid diagnostics in large-scale deployments. Additionally, these models can adapt to various fiber types and noise characteristics through further training or fine-tuning, providing flexibility and scalability for diverse use cases.

### Training

Training machine learning (ML) models for denoising OTDR traces involves a supervised learning process that requires a comprehensive dataset of noisy and clean OTDR signals. The dataset is typically composed of noisy input signals paired with clean (ground truth) signals obtained through methods such as high-fidelity averaging or simulations that mimic real-world conditions. During training, the noisy signals are input to the model, which generates a denoised output that is compared to the ground truth using a loss function, such as Mean Squared Error (MSE) or Mean Absolute Error (MAE). The loss function quantifies the difference between the predicted and actual clean signals, and the model's parameters are updated iteratively through backpropagation and optimization algorithms like Stochastic Gradient Descent (SGD) or Adam.

Different model architectures may be used depending on the application, including CNNs for spatial feature extraction, RNNs or Long Short-Term Memory (LSTM) networks for temporal sequence modeling, and hybrid models or Transformers for simultaneous spatial and temporal processing. Data augmentation techniques, such as simulating different noise levels or acquisition conditions, are often applied to enhance the robustness of the model. Regularization methods, including dropout and weight decay, help prevent overfitting.

Throughout the training process, the model's performance is validated using a separate dataset, with metrics such as Signal-to-Noise Ratio (SNR) improvement, resolution enhancement, and processing speed used to evaluate its effectiveness. Fine-tuning on domain-specific data may be performed to adapt the model for specific fiber types or noise profiles. Once trained and validated, the model can be deployed into the OTDR system, seamlessly integrating with acquisition and trace analysis modules. This enables efficient and accurate denoising of OTDR traces, reducing acquisition time and enhancing resolution, making it particularly valuable for high-speed, large-scale optical network testing.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. An Optical Time-Domain Reflectometry (OTDR) method comprising steps of:
applying OTDR pulses to a fiber under test and receiving noisy acquisition sets of the fiber under test;
processing the noisy acquisition sets with a denoising model that is a pre-trained machine learning model configured to simultaneously use spatial information and temporal information associated with the noisy acquisition sets to filter out noise; and
analyzing outputs from the denoising model to determine characteristics of the fiber under test.

2. The OTDR method of claim 1, wherein the steps further include providing or displaying a denoised OTDR trace.

3. The OTDR method of claim 1, wherein the denoising model includes multiple convolutional feature extractor layers configured to extract features from the spatial information and the temporal information of reflectometric signatures.

4. The OTDR method of claim 1, wherein the denoising model performs steps of:
receiving the noisy acquisition sets and extracting information across multiple ones of the noisy acquisition sets;
processing in parallel the noisy acquisition sets via a plurality of 1D convolutional layers each with different kernel sizes;
concatenating outputs of the plurality of 1D convolutional layers and processing the outputs via another 1D convolutional layer; and
providing an output corresponding to a prediction that is a combined, filtered version of the noisy acquisition sets.

5. The OTDR method of claim 1, wherein the processing utilizes the denoising model to filter out noise to reduce overall measurement time relative to averaging the noisy acquisition sets over time to filter out the noise.

6. The OTDR method of claim 1, wherein a denoised OTDR trace is provided after a first pass of the noisy acquisition sets through the denoising model, and the steps further include:
updating the denoised OTDR trace based on improvements thereto based on subsequent passes through the denoising model.

7. The OTDR method of claim 1, wherein the denoising model is one of a Neural Network (NN), a Recurrent Neural Network (RNN), and a Convolutional Neural Network (CNN).

8. The OTDR method of claim 1, wherein the denoising model includes multiple passes, and wherein, after each forward pass, the denoising model is configured to output a denoised signal and retain a hidden state of the fiber under test.

9. An Optical Time-Domain Reflectometer (OTDR) apparatus comprising:
an acquisition module configured to apply OTDR pulses to a fiber under test and receive noisy acquisition sets based thereon;
a denoising module connected to the acquisition module and configured to receive the noisy acquisition sets therefrom, wherein the denoising module is a pre-trained machine learning model configured to simultaneously use spatial information and temporal information associated with the noisy acquisition sets to filter out noise in the noisy acquisition sets; and
a trace analysis module connected to the denoising module and configured to use outputs from the denoising module to provide a denoised OTDR trace.

10. The OTDR apparatus of claim 9, wherein the denoising model is used to filter out the noise to reduce overall measurement time relative to averaging the noisy acquisition sets over time to filter out the noise.

11. The OTDR apparatus of claim 9, further comprising:
circuitry configured to:
provide the denoised OTDR trace which is provided after a first pass of the noisy acquisition sets through the denoising model; and
update the denoised OTDR trace based on improvements thereto based on subsequent passes through the denoising model.

12. The OTDR apparatus of claim 9, wherein the denoising model is one of a Neural Network (NN), a Recurrent Neural Network (RNN), and a Convolutional Neural Network (CNN).

13. The OTDR apparatus of claim 9, wherein each acquisition set of the noisy acquisition sets includes a reflectometric signature based on a corresponding applied OTDR pulse.

14. The OTDR apparatus of claim 13, wherein the denoising model includes a convolutional feature extractor layer configured to extract features for the spatial information and the temporal information from the reflectometric signatures.

15. The OTDR apparatus of claim 9, wherein the denoising model includes circuitry configured to:
receive the noisy acquisition sets and extracting information across multiple ones of the noisy acquisition sets;
process in parallel the noisy acquisition sets via a plurality of 1D convolutional layers each with different kernel sizes;
concatenate outputs of the plurality of 1D convolutional layers and processing the outputs via another 1D convolutional layer; and
provide an output corresponding to a prediction that is a combined, filtered version of the noisy acquisition sets.

16. The OTDR apparatus of claim 9, wherein the denoising model includes multiple passes, and wherein, after each forward pass, the denoising model is configured to output a denoised signal and retain a hidden state of the fiber under test.

17. A non-transitory computer-readable medium comprising instructions that, when executed, cause one or more processor to perform steps of:
applying Optical Time-Domain Reflectometry (OTDR) pulses to a fiber under test and receiving noisy acquisition sets of the fiber under test;
processing the noisy acquisition sets with a denoising model that is a pre-trained machine learning model configured to simultaneously use spatial information and temporal information associated with the noisy acquisition sets to filter out noise; and
analyzing outputs from the denoising model to determine characteristics of the fiber under test.

18. The non-transitory computer-readable medium of claim 17, wherein the processing utilizes the denoising model to filter out noise to reduce overall measurement time relative to averaging the noisy acquisition sets over time to filter out the noise.

19. The non-transitory computer-readable medium of claim 17, wherein a denoised OTDR trace is provided after a first pass of the noisy acquisition sets through the denoising model, and the steps further include:
updating a denoised OTDR trace based on improvements thereto based on subsequent passes through the denoising model.

20. The non-transitory computer-readable medium of claim 17, wherein the processing includes multiple passes, and wherein, after each forward pass, the denoising model is configured to output a denoised signal and retain a hidden state of the fiber under test.
